(19) United States
(12) Patent Application Publication
(10) Pub. No.: US 2006/0026648 A1
(43) Pub. Date: Feb. 2, 2006

(54) A DISPLAY CONTROLLING APPARATUS, METHOD, AND COMPUTER PROGRAM

(75) Inventors: Tomoharu KIRIHARA, Tokorozawa-shi, Saitama (JP); Wakako NAGATA, Tokorozawa-shi, Saitama (JP); Masaki KURIHARA, Tokorozawa-shi, Saitama (JP); Yoshiyuki YAMADA, Tokorozawa-shi, Saitama (JP); Kenji AZUMA, Tokorozawa-shi, Saitama (JP)

Correspondence Address: DVA/PEC-IPD, 2355 MAIN STREET, SUITE 200, IRVINE, CA, 92614, US

(73) Assignee: PIONEER CORPORATION, Meguro-ku, Tokyo (JP)

(21) Appl. No.: 11/161,328

(22) Filed: Jul. 29, 2005

(30) Foreign Application Priority Data
Aug. 2, 2004 (JP) 2004-225331

(51) Int. Cl. H04N 5/445; H04N 7/173; G06F 13/00

(52) U.S. Cl. 725/58; 725/100; 725/39

(57) ABSTRACT

A data-related information acquiring device acquires data related information having a distribution information. The distribution is related to the distribution of data. A data identification device identifies first data of which first distribution time extends or contracts on the basis of the data related information and second data of which second distribution time is changed by the extension or contraction of the first distribution time of the first data. A distribution-state display controlling device controls display information, which suggests a change in each of the distribution times in addition to the distribution information of the first data and the second data.

### CROSS REFERENCE TO RELATED APPLICATION

The present application claims priority under the Paris Convention to Japanese Patent Application No. 2004-225331, filed on Aug. 2, 2004.

### BACKGROUND OF THE INVENTION

1. Field of the Invention

The present invention relates to a display controlling apparatus, a method of controlling display, and a program for controlling display.

2. Related Art

In a conventional technique, a structure that a bill of fare is displayed on the basis of an electric program guide (EPG) which is sent as program information utilizing broadcast wave.

In this structure, a program reservation device, a video tape recorder (VTR) A, a video tape recorder (VTR) B, or the like are included. In a state that a reservation program 1 and a reservation program 2 are reserved for recording, when it is judged that a reserved program 1 and a reserved program 2 are reserved for the record in the VTRA, the program reservation device judges that there is a possibility that the duration of the reserved program 1 is extended to cause an overlap of durations of the reserved program 1 and the reserved program 2, the following process is done. Namely, in order to cancel the overlap of the duration, the reserved program 2 is shifted from the VTRA to the VTRB.

However, when a program A which will be broadcasted after a reserved program 1 of which duration is possibly extended is reserved for recording in a channel same as that of the program 1, there is, for example, a problem that it may be impossible to judge whether or not the airdate of the program A occurred.

The present invention is provided to solve the above problems and to provide a display controlling apparatus, which can properly display a state of data distribution, a method of controlling the display, and a program for controlling display.

### BRIEF DESCRIPTION OF THE DRAWINGS

In the accompanying drawings:

FIG. 1 is a block diagram for showing a schematic structure of a recording and reproducing system according to one embodiment of the present invention;

FIG. 2 is a pattern diagram for showing a schematic structure of a processing unit that forms the recording and reproducing device according to one embodiment of the invention;

FIG. 3 is a pattern diagram for showing an example of a screen of a bill of fare or program listing according to one embodiment of the invention;

FIG. 4 is a pattern diagram for showing an example of a screen for setting up a reservation for recording according to one embodiment of the invention;

FIG. 5 is a flow chart for showing a process for setting a reservation for recording using EPG data according to one embodiment of the invention; and

FIG. 6 is a flow chart for showing a process for setting up a reservation for recording using EPG data according to one embodiment of the invention.

### DESCRIPTION OF THE EMBODIMENTS

According to one aspect of the invention, the display controlling apparatus comprises a data-related information acquiring device for acquiring a data related information having distribution information related to distribution of data, a data identification device for identifying first data having first distribution time where the first distribution time is extended or contracted on the basis of the data related information and second data having second distribution time where the second distribution time is changed by the extension or contraction of the first distribution time of the first data and a distribution-state display controlling device for controlling to display an information which suggests a possibility of changing each of the distribution times in addition to the distribution information of the first data and the second data.

The data-related information has content character information showing the content of the data, and the distribution-state display controlling device controls to display at least one of the first and second distribution information and information which suggests a change in one of the first and second data in a display mode corresponding to a content of the content character information pieces.

The distribution-state display controlling device controls to display at least one of the first and second distribution information and first and second information which suggest a change of each of the first and second data in a display mode corresponding to the first distribution time where the distribution time is extended or contracted. Furthermore, the distribution-state display controlling device controls to display at least one of the first distribution information and the first information which suggests a change in a display mode different from at least one of the second distribution information and the second information which suggests the change. The difference of display mode is caused by any one of the size, brightness, hue or color saturation of the display.

Another aspect of the invention where the display controlling apparatus comprises a requested information acquiring device for acquiring a requested information which result in making the data acquisition device to acquire the data and an acquisition-condition display controlling device for controlling to display acquisition conditions of the first and second data to be displayed on the display device by means of a display mode different from display modes of the data different from the first and second data when it is recognized that the data of which acquisition condition is requested are the first or second data. The difference of display mode is caused by any one of the size, brightness, hue or color saturation of the display.

The acquisition-condition display controlling device controls to display acquisition-TOD-change prompting information piece, which prompts a change of TOD as the acquisition condition of the first or second data. Furthermore, the acquisition-condition display controlling device controls to display (1) a predetermined time information for showing a predetermined time, which is obtained by adding to or subtracting from a TOD of the distribution time presuming that there is neither extension nor contraction at the time of changing the TOD of the acquisition time, (2) an extension or contraction time information for showing the extended or contracted time as the predetermined time information.

The data-related information has a content character information showing the content of the data, and the data identification device identifies data corresponding to the content character information as the first data when it is recognized that an extension or contraction character information where the content character information is extended or contracted. The data identification device recognizes an end TOD of the first distribution time of the first data, and identifies the data distributed within the predetermined time from the end TOD as the second data.

Another aspect of the invention where a display controlling method for controlling to display a distribution condition of data comprises: (1) acquiring data related information having a distribution information which relates to distribution of the data, (2) identifying first data of which first distribution time is extended or contracted on the basis of the distribution information and second data of which second distribution time is changed by the extension or contraction of the first distribution time of the first data, and (3) controlling to display the information which suggests a change in one of the distribution times in addition to the distribution information of the first data and the second data. The data-related information mentioned above has content character information that shows the content of the data.

Yet another aspect of the invention is a computer product having a program tangibly demonstrating function of controlling to display a distribution condition of data comprises: (1) acquiring data related information having distribution information which relates to distribution of the data; (2) identifying first data of which first distribution time is extended or contracted on the basis of the distribution information and second data of which second distribution time is changed by the extension or contraction of the first distribution time of the first data, and (3) controlling to display the information which suggests a change of each of the distribution times in addition to the distribution information of the first data and the second data.

Embodiments of the present invention will be described in conjunction with the figures. Hereinafter, each meaning of the numerical references is as follows: numerical reference 210 designates a tuner unit which also works as a data acquisition means, numerical reference 250 designates a process unit as a calculation means, numerical reference 251 designates an EPG acquisition control means as a data-related information acquiring means which forms a display control device, numerical reference 252A designates a schedule-changed program identification means as a data identification means which forms the display control device, numerical reference 252B designates a bill-of-fare screen setting means as a distribution-state display controlling means which forms the display control device, numerical reference 253A designates a reserved screen display control means as an acquisition-condition display controlling means which also works as a requested information acquiring means which forms the display control device, numerical reference 320 designates a display unit as a display means, and numerical reference 41 7 designates a schedule changing icon as an information piece suggesting a possibility of change. Furthermore, in the embodiments, TOD designates time of day or date and hour.

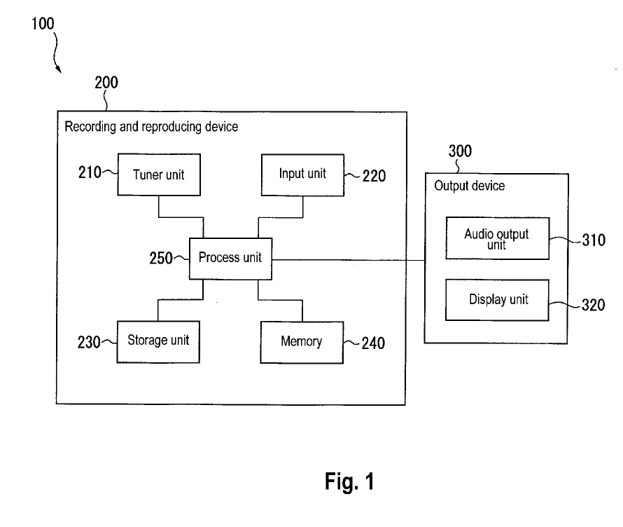

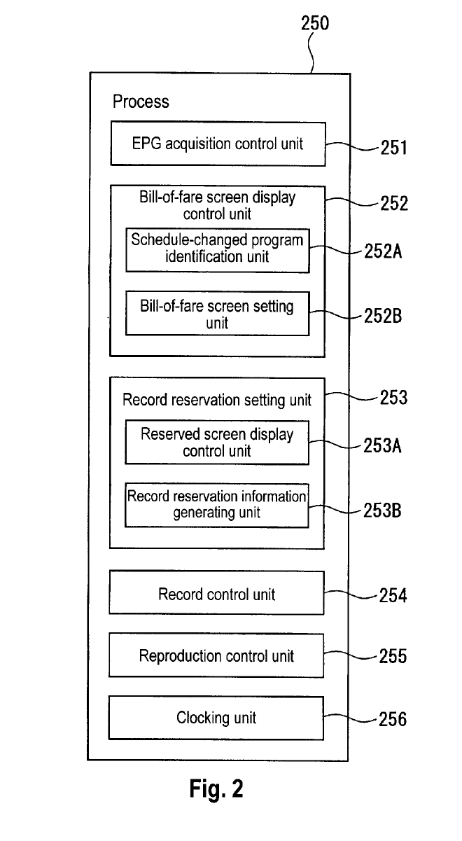

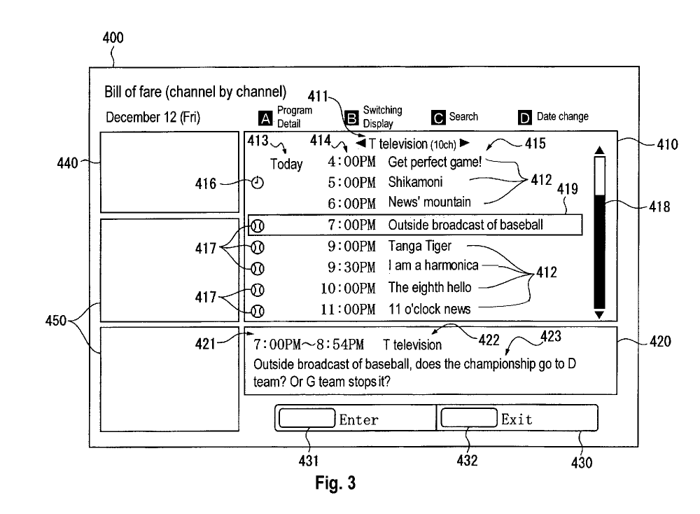

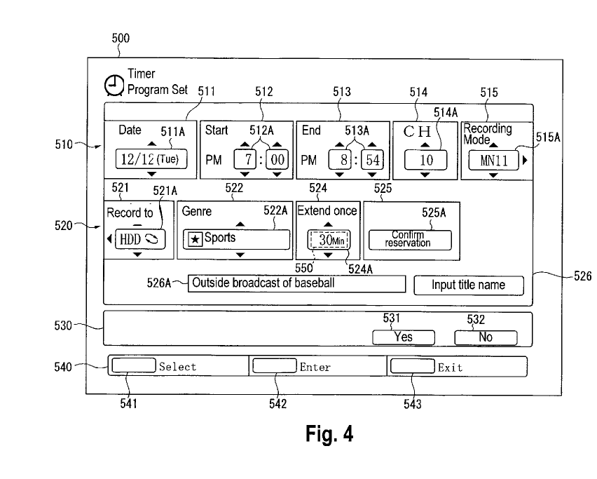

Although in this embodiment, a recording and reproducing device including a display controlling apparatus according to the present invention is exemplified in explanation, the invention is not limited thereto and any structure which can recognize various data distribution states is applicable to the invention. FIG. 1 is a block diagram for showing a schematic structure of a recording and reproducing system according to an embodiment of the present invention. FIG. 2 is a pattern diagram for showing a schematic structure of a processing unit that forms the recording and reproducing device according to the embodiment. FIG. 3 is a pattern diagram for showing an example of a screen of a bill of fare according to the embodiment. FIG. 4 is a pattern diagram for showing an example of a screen for setting up a reservation for recording according to the embodiment.

Construction of Recording and Reproducing System

In FIG. 1, numerical reference 100 designates a recording and reproducing system which is a system of recording program data as data including audio data, image data, or the like or reproducing the recorded program data. The recording and reproducing system 100 has a recording and reproducing device 200 and an output device 300.

The output device 300 receives program data or the like, which are inputted from the recording and reproducing device 200. The output device 300 has an audio output unit 310, a display unit 320 as a display means, or the like. The audio output unit 310 has for example an enunciation means such as a speaker (not shown). The audio output unit 310 outputs audio data, which are sent from the recording and reproducing device 200 as audio signals in a mode of an audio. The display unit 320 displays image data, which are sent from the recording and reproducing device 200 as image signals. Examples of the display unit 320 are a liquid crystal display, an organic electro luminescence panel (EL), a plasma display panel (PDP), a cathode-ray tube (CRT), a field emission display (FED), and an electrophoretic display panel.

The recording and reproducing device 200 acquires program data including audio data, image data, or the like which are distributed in use of a broadcast wave, and conducts a process of making the output device 300 output the program data. The recording and reproducing device 200 conducts a process of appropriately reproducing the recorded program data and outputting the program data from the output device 300. Furthermore, the recording and reproducing device 200 acquires electric program guide (EPG) data as data related information piece which is distributed from a predetermined broadcast station in use of a broadcast wave and makes the output device 300 output a bill of fare screen 400 based on the EPG data in reference of FIG. 3. The recording and reproducing device 200 has a tuner unit 210 which also works as a data acquisition means, an input unit 220, a storage means 230, a memory 240, a process unit 250 as a calculation means, and so on.

A television antenna (not shown) for receiving a broadcast wave is connected to the tuner unit 210. The tuner unit 210 acquires various data, i.e. program data or EPG data, which corresponds to a predetermined channel out of various data, which are sent from the television antenna in correspondence with a plurality of channels, and outputs these data to the process unit 250.

The EPG data has a table data structure in which a plurality of individual program information pieces which are respectively related to each of the programs, for example, in a text form are constructed as a single data. The individual program information pieces are, for example, a channel information piece, a title information piece, a detailed program information piece, a broadcast time of day (TOD) information piece, a large genre information piece, a small genre information piece and so on. In this, the title information piece, the broadcast TOD information piece, and the channel information piece perform as a delivery or distribution information piece according to the present invention, and the detailed program information piece and the large genre information piece perform as a content character information piece according to the present invention. The channel information piece relates to a channel number, a broadcast station name and so on. The title information piece relates to a program name. The detailed program information piece relates to a detail of a program such as the content of the program, a performer and so on. In a case of a program, such as a sport relay broadcast, of which broadcast time may be extended, the detailed program information piece further includes a character string such as “until a maximum of 9:24 PM” to show the possibility of the extension. In this, the character string of “extended” performs as an extension and contraction character information piece, which is contained in the detailed program information piece according to the invention. In the following description, a program, such as a sport relay broadcast, of which broadcast time may be prolonged, is referred to as an extension program. On the other hand, a program of which broadcast starting time is delayed is referred to as a delay program. Furthermore, when the extension program and the delay program are collectively expressed, a schedule change program is suitably used as their reference. The broadcast TOD information piece relates to a broadcast start TOD and a broadcast end TOD of a program. The large genre information piece relates to a rough classification of programs such as “sport”, “variety”, and “drama”. In this, the character string such as “sport” included in the large genre information piece performs as a sport character information piece. A small genre information piece relates to a genre smaller than the large genre information such as “baseball”, “tennis” and “soccer”.

The input unit 220 includes a remote controller (hereinafter referred to as an RC device, not shown in the figure), a light receiving unit of the RC device which is located in conformity with a detection window (not shown in the figures) which is located in a downward portion on a front side of a casing (not shown in the figures) in the recording and reproducing device 200, and so on. The remote controller has an operation means (not shown in the figures), a signal generation means, and so on. The operation means has various operation buttons and operation knobs (both not shown in the figures), which are located, for example, in front of a remote control casing (not shown in the figures). Input operations with respect to the operation means are for example contents of operation of the recording and reproducing device 200 such as setting of channel which is received by the tuner unit 210, reproduction of program data, setting of recording. The signal generation means appropriately outputs an operation signal corresponding to the input operation and outputs it to the remote control light receiving unit of the unit in use of an infrared ray. The light receiving unit of the RC device receives an infrared ray from the RC device and outputs the operation signal of the infrared ray to the process unit 250 to thereby set up various items.

The storage means 230 memorizes the program data and so on so as to be appropriately readable under a control of the process unit 250. The storage means 230 includes an HD drive (not shown in the figures) which makes a hard disk (HD) memorize various information pieces so as to be readable, and a DVD drive (not shown in the figures) which makes a digital versatile hard disk (DVD) memorize various information pieces so as to be readable. Although the structure that the HD drive and the DVD drive are contained in the storage means is exemplified, it is also possible to adopt structures such that any one of the HD drive and the DVD drive is equipped, that at least any of a drive, a driver and another device which make various recording mediums such as another magnetic disk, another optical disk, and another memory card memorize the various information pieces so as to be readable, and that a plurality of the above-described structures are combined.

The memory 240 memorizes a setting item which is inputted from the input unit 220, various information pieces which are obtained or generated by the process unit 250, audio data, image data, EPG data, and so on so as to be appropriately read out. Furthermore, the memory 240 memorizes a record reserving information piece which is used at a time of performing a process of reserving record so as to be appropriately read out. The record reserving information piece is a single data structure made up of a record date information piece, a record start time information piece, a record end time information piece, a record channel information piece, a record mode information piece, a recording destination information piece, a record genre information piece, a record title information piece and so on so as to be mutually correlated. The record date information piece is an information piece which relates to a date when the recording is performed. The record start time information piece relates to a time when a record is started. The record end time information piece is an information piece related to a time when recording is completed. The recording channel information piece is an information piece related to a channel of a program to be recorded. The recording mode information piece is an information piece related to a mode of recording.

Specifically, it is an information piece of designating a record mode (hereinafter referred to as a manually set recording mode), which is manually set up, or a predetermined mode (hereinafter referred to as a preset recording mode). The recording destination information piece is an information piece for specifying a recording medium in which program data are recorded. The record genre information piece is an information piece, which relates to the genre of a program to be recorded. The record title information piece is an information piece, which relates to a title of program to be recorded.

Furthermore, the memory 240 memorizes various computer programs, which are deployed over an operating system (OS) for controlling an operation of the entirety of the recording and reproducing device 200. The memory 240 is preferably a memory having a structure that memorized data are maintained even though a power source is suddenly shut off by for example by a power outage, e.g. a complementary metal oxide semiconductor (CMOS) memory. It is also possible to use a structure having at least any of a drive, a driver and another device which makes a recording medium such as an HD, a DVD and an optical disk record data so as to be readable there from.

The process unit 250 includes various input and output ports (not shown in the figures), for example an output control port to which the output device 300 is connected, a TV port to which a TV antenna is connected, a key input port to which the input unit 220 is connected, a memory port to which the memory means 230 is connected, and a memory port to which the memory 240 is connected. As shown in FIG. 2, the process unit 250 includes as the various computer programs such as an EPG acquisition control means 251 as a data-related information acquiring means, a bill-of-fare screen display control means 252, a record reservation setting means 253, a record control means 254, a reproduction control means 255, and a clocking means 256.

The EPG acquisition control means 251 appropriately acquires EPG data by controlling an operation of the tuner unit 210. Specifically, the EPG acquisition control means 251 appropriately acquires a current time of day information piece to be described below from the clocking means 256 in a state that program data are not acquired in the tuner unit 210. When it is recognized that a predetermined time for distributing the EPG data arrives, it appropriately controls the operation of the tuner unit 210 to thereby make it acquire the EPG data. Furthermore, the EPG acquisition control means 251 acquires the EPG data acquired by the tuner unit 210 and makes the memory 240 memorize the EPG data so as to be appropriately readable.

The bill-of-fare or program listings screen display control means 252 makes a display unit 320 of an output device 300 appropriately display a bill-of-fare screen 400 as shown in FIG. 3 on the basis of the EPG data which are memorized in the memory 240. The bill-of-fare screen display control means 252 includes schedule-changed program identification means 252A as a data identification means and a bill-of-fare screen setting means 252B as a distribution-state display controlling means.

The data identification means 252A appropriately identifies a schedule change program out of the EPG data. Specifically, when the data identification means 252A receives an operation signal of displaying a bill-of-fare screen 400 on the basis of an input operation from the input unit 220 or an operation signal of performing a record reservation setting on the basis of the EPG data, it receives the EPG data from the memory 240. Furthermore, it searches, for example, an individual program information piece which contains a character string, e.g. “extension”, which designates a possibility of extension in a detailed program information piece out of the EPG data and of which genre in a large genre information piece is “sport”. Thus a program corresponding to the individual program information piece thus searched is identified as an extension program. Although the character string “extension” is exemplified as the character string for showing that there is a possibility of extending the program, the character string is not limited thereto and any character string such as “change” and “extend” can be used as long as a possibility of the extension is expressed therein. Furthermore, when there is a possibility of extending the genre of the large genre information piece is changed, it is also possible to adopt a structure such that a program of another genre is appropriately searched, for example a structure that an individual program information piece “news” corresponding to a news report program is searched.

When the schedule-changed program identification means 252A could search an extension program, the broadcast end time of the extension program is recognized. It is also possible to recognize the time, which is shown in the character string of, for example, “until a maximum extension of 9:24 PM” as the broadcast end time of the extension program. The program data of the searched extension program performs as first data of the present invention. When the schedule-changed program identification mean 252A recognizes that the broadcast end time of the extension program is, for example, a time zone of from 5 A.M. to 12 A.M. (noon) (hereinafter referred to as a morning time zone), a program which is broadcasted after the extension program and of which broadcast start time is in the morning time zone is identified as a delay program. Furthermore, when it is recognized that the broadcast end time is in a time zone of from 12 A.M. (noon) to 7 P.M. (hereinafter referred to as an afternoon time zone), a program which is broadcasted after the extension program and of which broadcast start time is in the afternoon time zone is identified as the delay program. Furthermore, when it is recognized that the broadcast end time is in a time zone of from 7 P.M. to 12 P.M. (midnight) (hereinafter referred to as a night time zone), a program which is broadcasted after the extension program and of which broadcast start time is in the night time zone is identified as the delay program. In this, for example, when there is an extension program in the morning time zone, a broadcast time of day (TOD) of a program in the afternoon time zone is frequently adjusted so as not to delay by ceasing a program which is scheduled after the extension program or shortening a broadcast time duration in the morning time zone. Furthermore, a program is frequently adjusted when an extension program exists in the afternoon time zone or the night time zone in a manner similar thereto. Therefore, the structure of identifying the delay program in accordance with the above-described process is adopted. Meanwhile, the program data of the identified delay program perform as the second data according to the present invention. Furthermore, although the structure that the broadcast start time identifies programs in each of the time zones as the delay program is exemplified, the structure is not thereto and a structure such that the delay program is identified in use of the broadcast end time is applicable.

The bill-of-fare screen setting means 252B appropriately sets up a display mode of the bill of fare screen 400 on the basis of the EPG data and/or the result of the identifying process of the schedule-changed program in the schedule-changed program identification means 252B. Specifically, the schedule-changed program identification means 252B acquires the EPG data and controls to display the bill of fare screen 400, which is based on the EPG data on a display area (not shown) of the display unit 320. In this, although a structure of displaying the bill of fare screens 400 channel by channel is described as an example, a bill of fare screen in displaying bill of fare screens according to other structures of such as genre by genre and time by time can be displayed in a manner similar thereto. The bill of fare screen 400 has a basic information area 410, a content information area 420, an operation selection area 430, a receipt image area 440, and a pair of advertising image areas. Although a structure that the program screen 400 has the above-mentioned areas 410, 420, 430, 440 and 450 is described in this example, another structure such that any of the areas 440 and 450 is not included may be adopted in an appropriate manner.

The basic information area 410 is located on the bill of fare screen from its right side to a leftward position of the center in the horizontal directions. For example, a channel name 411, which is based on the channel information piece of the EPG data, is displayed at a position of substantially the center of an upward position on the basic information area 410. Furthermore, at a downward position of the channel name 411, a plurality of basic information pieces, which relate to the channel information pieces of the EPG data are arranged in the vertical directions and displayed. The basic information piece includes a broadcast date 413, a broadcast start time 414 and a program name. At the left side positions of each of the basic information pieces 412, a record reservation icon 416 for showing that a record reservation is set up for the program and a schedule changing icon 417 as an information piece of suggesting a possibility of schedule change in a shape of a baseball cantaloupe are appropriately displayed. In this, the suggestion of a possibility of change is to suggest there may be a case where the broadcast time duration is extended. Although the baseball cantaloupe is exemplified as the shape of the schedule change icon 417, the shape is not limited thereto and any appropriate shape such as a character string “schedule is changing” and a soccer ball. Furthermore, on the right side of the basic information area 410, a scroll bar 41 8 for showing whether or not the basic information piece 412, which relates to a program to be broadcasted before and after the program of the currently displayed basic information piece 412 is displayed. Furthermore, on the basic information area 410, a selection cursor 419 is displayed in a state that any one of the plurality of basic information pieces 412 and an icon corresponding to this basic information piece 412 among the icons 416 and 417. The selection cursor 419 is appropriately moved in the vertical directions in response to an operation signal that is generated by an input manipulation into the input unit 220.

The content information area 420 is located below the basic information area 410. On the content information area 420, various information pieces, which relate to the program of the basic information piece 412 surrounded by the selection cursor 419. Specifically, a broadcast time of day (TOD) 421 and a channel name 422 are displayed side by side on the upper left side of the content information area 420 in the horizontal directions, and a program content 423 that is based on a detailed program information piece among the individual program information pieces is displayed from the substantially center position in the vertical directions to a downward position.

The operation selection area 430 is located below the content information area 420. On the operation selection area 430, an Enter button 431 which is selected when the program of the basic information piece 412 surrounded by the selection cursor 419 is set up for record reservation and an Exit button 432 which is selected when the display of the bill of fare screen 400 is ended are displayed side by side.

The receipt image area 440 is located on the left side of the basic information area 410 and in the vicinity of the left corner end of the bill of fare screen 400. On the receipt image area 440, image data of the program data, which are currently acquired in the tuner unit 210, are appropriately displayed.

The pair of advertising image areas 450 are up and down arranged in the vertical directions on the lower side of the receipt image area 440. The advertising data, which are distributed along with, for example EPG data, are appropriately displayed on the advertising image areas 450.

The record reservation setting means 253 appropriately conducts a process of setting up recording reservation. The record reservation setting means 253 includes a reserved screen display control means 253A as an acquisition-condition display controlling means which performs also as a requested information acquiring means, a record reservation information generating means 253B and so on.

The reserved screen display control means 253A appropriately displays a timer program set screen 500 shown in, for example, FIG. 4 on an output device 300. Specifically, when the reserved screen display control means 253A acquires an operation signal for selecting the Enter button 431 on the basis of an input manipulation through the input unit 220 under a state that any of the basic information piece 412 is selected by the selection cursor 419, it is judged whether or not the schedule changing icon 417 is displayed on the left side of the basic information piece 412. Then the reserved screen display control means controls to display the timer program set screen 500 on a display area 320 in a display mode based on the judgment.

The timer program set screen 500 includes a first set-up condition area group 510, a second set-up condition area group 520, a confirm selection area 530, an operation selecting area 540 and so on.

The first set-up condition area group 510 is upward located on the timer program set screen 500. The first set-up condition area group 510 includes a record date area 511, a record start time area 512, a provisional record end time area 513, a record channel area 514, a record set-up mode area 515 and so on which are arranged in the horizontal directions.

The record date area 511 has a record date part 511A substantially in a rectangular shape on which a date when recording is planned is displayed. On the record date part 511A, a broadcast date 413 of a basic information piece 412 that is surrounded by, for example, a selection cursor 419 is displayed.

The record start time area 512 has a pair of record start time portions 512A substantially in a square shape on which a date when the recording is planned to start is displayed. On the record start time portions 512A, a broadcast start time 414 that is obtained on the basis of the basic information piece 412 which is surrounded by for example, a selection cursor 419 is displayed.

The provisional record end time area 513 has a pair of provisional record end time portions 513A substantially in a square shape on which a provisional date when the recording is planned to end is displayed. On the provisional record end time portions 513A, a broadcast end time that is obtained on the basis of the broadcast TOD information piece of the program corresponding to the basic information piece 412 which is surrounded by, for example, a selection cursor 419 is displayed.

The record channel area 514 has a record channel portion 514A substantially in a rectangular shape on which a channel where a program to be recorded is broadcasted is displayed. On the record channel portion 514A, the channel that is obtained on the basis of the channel information piece corresponding to the program of the basic information piece 412 which is surrounded by, for example, a selection cursor 419 is displayed.

The record set-up mode area 515 has a record mode portion 515A substantially in a rectangular shape on which a record mode is displayed. On the record mode portion 515A, character strings such as “MNi (where the reference i represents, for example, a positive integer of 1 to 32)” for showing, for example, a manual record set-up mode, which is set up at a time of previous record reservation and “FINE”, “SP”, “LP”, “EP”, and “SLP” each showing predetermined record set-up modes are displayed.

The second set-up condition area group 520 is located below the first set-up condition area group 510. The second set-up condition area group 520 includes a record destination area (“Record to”) 521, a genre area 522, an extension time area 524, a reservation set-up area 525, a title name area 526, and so on which are arranged side by side.

The record destination area 521 has a record destination portion 512A substantially in a rectangular shape on which a type of a recording medium for recording a program. On the record destination portion 512A, character strings such as “HDD” showing that the recording medium is an HD and “DVD” showing that the recording medium is a DVD which are set up at a time of previous record reservation are displayed.

The genre area 522 has a genre portion 522A substantially in a rectangular shape on which a genre of a program to be recorded is displayed. On the genre portion 522A, a character string such as “variety” showing the large genre of the program corresponding to the basic information piece, which is surrounded by, for example, a selection cursor 419 is displayed.

The extension time area 524 has an extension time portion 524A substantially in a rectangular shape on which a time duration of extending a recording time is displayed. In this, on the extension time portion 524A, a character string “30 minutes” showing that a recording time duration is extended by 30 minutes is first displayed. Furthermore, character strings “60 minutes” showing that a recording time duration is extended by 1 hour, “90 minutes” showing that a recording time duration is extended by 1 hour and 30 minutes, “120 minutes” showing that a recording time duration is extended by 2 hours, “0 minute” showing that a recording time duration is not extended are appropriately displayed. Meanwhile, although a structure that the time to be extended is displayed so as to be set up at an interval of every 30 minutes is exemplified in this example, the invention is not limited thereto and a structure such that the interval is set up, for example, at every 15 minutes or every 1 minute can be adopted.

The reservation set-up area 525 has a reservation set-up portion 525A substantially in a rectangular shape on which an information piece related to a set-up condition of a record reservation is displayed. On the reservation set-up portion 525A, a character string such as “reservation is confirmed” showing that the reservation is confirmed in accordance with, for example, the contents of numerical references 511 to 515 and 521 to 526 is displayed.

The title name area 526 has a title name portion 526A substantially in a rectangular shape on which a title of a program to be recorded is displayed. On the title name portion 526A, the title, which is obtained on the basis of the title information piece of the program corresponding to the basic information piece that is surrounded by, for example, a selection cursor 419, is displayed.

The confirm selection area 530 is located below the second set-up condition area group 520. On the confirm selection area 530, a confirm button 531 substantially in a rectangular shape which is selected when a record reservation is confirmed in accordance with the contents shown in the area groups 510 and 520 and a non-confirm button 532 substantially in a rectangular shape which is selected when a record reservation is not confirmed are arranged in the horizontal directions side by side.

The operation selecting area 540 is located below the confirm selection area 530. On the operation selecting area 540, a Select button 541 which is used when a set-up cursor 550 which is displayed on any of the areas 511 to 515 and 521 to 526 and buttons 531 and 532 is moved, an Enter button 542 substantially in a rectangular shape which is selected at a time of changing a display content of the areas 511 to 515 and 521 to 526, and an Exit button 543 substantially in a rectangular shape which is selected when a display of the record reservation setting screen is finished are arranged in the horizontal directions side by side.

When the reserved screen display control means 253A judges that the selected program is a schedule change program, it makes the set-up cursor 550 first display on the extension time area 524 for example as shown in FIG. 4. Furthermore, it makes a character string “30 minutes” showing that a recording time duration is extended by 30 minutes display on the extension time area 524 regardless of the time duration while the extension program is to be extended. Although a case where the recording time is extended by 30 minutes is exemplified, the invention is not limited thereto and, another structure such that an extension of 1 hour, 1 hour and 30 minutes or 2 hours is first displayed can be appropriately adopted. Furthermore, although it is not illustrated in the figure, when it is recognized that the selected program is not the schedule change program, the set-up cursor 550 is first shown on the confirm button 531, and “0 minute” showing that a recording time duration is not extended is displayed on the extension time portion 524A.

The reserved screen display control means 253A makes the timer program set screen 500 display after an operation signal for manually setting a record reservation on the basis of an input operation through the input unit 220, wherein, for example, respective information pieces are not displayed on each portions 511A to 515A and 521A to 526A of the timer program set screen 500. In this, it is possible to adopt structures such that a current TOD is displayed on the record date portion 511A and the record start time portions 512A and that a channel which is set up with respect to the tuner unit 210 display on the record channel portion 514A. Then the various information pieces corresponding to the operations signals of selecting the Enter button 542 of the input unit 220 are displayed on the portions 511A to 515A and 521A to 526A.

The record reservation information generating means 253B generates the record reserving information piece on the basis of the content of the timer program set screen 500. Specifically, for example, when the record reservation information generating means 253B receives an operation signal of selecting the confirm button 531 on the basis of the input operation through the input unit 220, the request for setting up the record reservation is recognized. Then the record reservation information piece is generated. In other words, when “0 minute” representing that the record time is not extended is displayed on the extension time portion 524A, a record reservation information piece in which the date of the record date portion 511A is built in as a record date information piece; the time of the record start time portions 512A is done as a record start time information piece; the time of the provisional record end time portions is done as a provisional record end time information piece; the channel of the record channel portion 514A is done as a record channel information piece; the record mode of the record mode portion 515A is done as a record mode information piece; the recording medium of the record destination portion 521A is done as a record destination information piece; the genre of the genre portion 522A is done as a genre information piece; and the title of the title name portion 526A is done as title name information piece. Thereafter, when for example a character string showing the extension is displayed on the extension time portion 524A, i.e. a character string of other than “0 minute” is displayed, the record reservation information piece in which a time after elapsing the time on the extension time portion 524A from the time on the provisional record end time portions is built in is generated.

The display control apparatus according to the present invention is made up of the EPG acquisition control means 251, the schedule-changed program identification means 252A, the bill-of-fare screen setting means 252B and the reserved screen display control means 253A. However, it is possible to omit the reserved screen display control means 253A from the display control apparatus according to the present invention.

The record control means 254 controls to memorize the program data to the memory means 230. Specifically, the record control means 254 appropriately controls the operation of the tuner unit 210 on the basis of the record reservation information piece, which is memorized in the memory 240 to thereby make program data of which record start time is the present time counted by the clocking means obtain. Furthermore, the record control means 254 controls to acquire the program data, which are preferred by a user, and makes the program data thus acquired memorize in the storage means 230. Specifically, the record control means 254 acquires the program data, which are presently acquired by the tuner 210 in accordance with an operation signal based on an input manipulation through the input unit 220. Then the program data are memorized in the storage means 230.

The reproduction control means 255 processes to output the program data, which are memorized in the storage means 230 to the output device 300 and reproduce the program data. Specifically, the reproduction control means 255 reads out program data which are determined by an operation signal which is based on an input manipulation through the input unit 220, for example program data which are determined by an input manipulation of selecting out of a thumbnail-size image list displayed, or program data which are requested to read out of the storage means 230 at a predetermined time as in a timer reproduction. The program data are outputted to the output device 300 and reproduced.

The clocking means 256 calculates the present TOD on the basis of, for example, a reference pulse such as an internal clock. The present TOD information piece related to the present information TOD is thus calculated.

Operation of Recording and Reproducing System

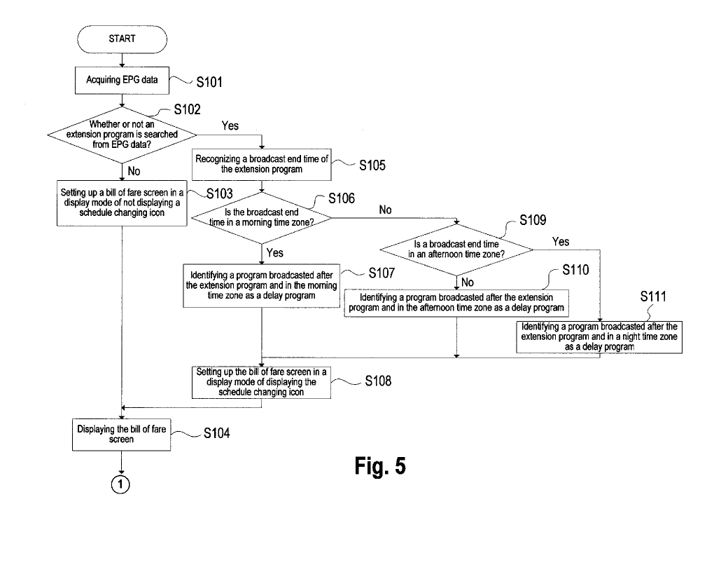

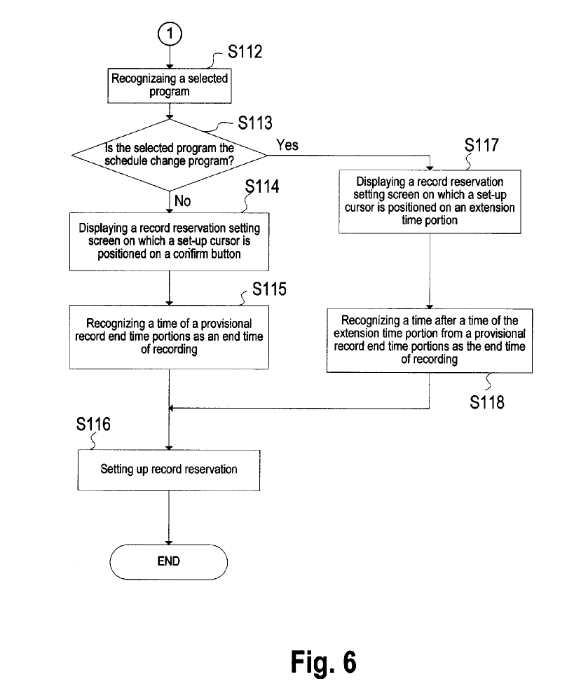

Next, as an operation of the recording and reproducing system 100, a record reservation setting process using the EPG data is described in reference of the figures. In this, a record reservation setting process using EPG data, of which content is, for example, a detailed program information piece having a character string of “to be extended until a maximum of 9:24 PM” and a large genre information piece designating that the genre is “sport” as shown in FIG. 3, is exemplified for explanation. FIGS. 5 and 6 are flow charts showing the record reservation setting process using the EPG data.

A user inputs to set up for conducting the record reservation setting process using the EPG data through an input manipulation through the input unit 220. After a request for conducting a record reservation setting process is recognized by the schedule-changed program identification means 252A of the bill-of-fare screen display control means 252, the recording and reproducing device 200 acquires the EPG data memorized in the memory 240 in Step S101. Thereafter, the schedule-changed program identification means 252A searches the extension program out of the EPG data and judges whether or not the search is successful in Step S102.

When the bill-of-fare screen display control means 252 judges that the extension program is not searched by the schedule-changed program identification means 252A in the Step S102, in other words it is judged that the schedule-changed program does not exist, the display mode of the bill of fare screen 400 is set up to be in a mode that schedule changing icon 417 is not displayed by the bill-of-fare screen setting means 252B in Step S103. Thereafter, the distribution-state display controlling means 252B makes the bill of fare screen 400, which is based on the set-up display mode display on the output device 300 in Step S104. In this, when the process of the Step S103 is in the course of conducting, the bill of fare screen 400 without the schedule changing icon 417 on it is displayed as described above.

Meanwhile, in Step SI 02, the data identification means 252A judges that the extension program can be searched; the broadcast end time of the extension program is recognized in Step S105. For example, “outside broadcast of baseball” corresponding to a detailed program information piece having a character string of “to be extended until a maximum of 9:24 PM” and a large genre information piece designating that the genre is “sport” is identified as the extension program. Furthermore, it is recognized that the broadcast end time of “outside broadcast of baseball” is 8:54 PM. Thereafter, the recognized broadcast end time is in the morning time zone or not in Step S106.

When it is judged that the broadcast end time is in the morning time zone in Step S106, a program which is broadcasted after the extension program and of which broadcast start time is in the morning time zone is identified as a delay program in Step S107. Furthermore, the bill-of-fare screen setting means 252B sets up the display mode of the bill of fare screen 400 in a mode of displaying the schedule changing icon 417 on the left side of the basic information piece 412 corresponding to the schedule change program, namely the extension program and the delay program, in Step S108. Thereafter, the bill-of-fare screen setting means 252B conducts the process of the Step S104 to thereby display the bill of fare screen 400 on the output device 300. When the process of Step S108 is conducted, the bill of fare screen 400 which has a schedule changing icon 417 on it as described above, for example the bill of fare screen 400 as shown in FIG. 3, is displayed.

Furthermore in Step S106, when it is judged that the broadcast end time is not in the morning time zone in Step S106, it is judged whether or not it is in the afternoon time zone in Step S109. When it is judged that the broadcast end time is not in the afternoon time zone in Step S109, a program which is to be broadcasted after the extension program and of which broadcast start time is in the afternoon time zone is identified as the delay program in Step S110. Furthermore, the bill-of-fare screen setting means 252B conducts the process of Step S108. On the other hand, when it is judged that the broadcast end time is not in the afternoon time zone, it is judged to be in the night time zone. Then the program which is started to be broadcasted after the extension program and of which broadcast start time is in the night zone is identified as the delay program in Step S111, and the process of Step S108 is conducted. In this, it is judged that the broadcast end time of “outside broadcast of baseball” is in the night time zone, a program which is started to be broadcasted after “outside broadcast of baseball” and of which broadcast start time is in the night time zone, for example “Program 1 (Tanga Tiger)”, “Program 2 (I Am A Harmonica)”, “Program 3 (The Eighth Hello)” and “Program 4 (11 o'clock News)”, is identified as the delay program of which broadcast start time is until 5 AM next morning. Then, on the left sides of each of “outside broadcast of baseball” which is identified as the extension program and the basic information pieces 412 such as “Program 1 (Tanga Tiger)”, “Program 2 (I Am A Harmonica)”, “Program 3 (The Eighth Hello)” and “Program 4 (11 o'clock News)”, schedule changing icons are respectively displayed.

Thereafter, a user moves the selection cursor 419 to the basic information piece 412 of the program to which the record reservation is intended to set up by means of an input manipulation through the input unit 220, for example the selection cursor is moved to the basic information piece 412 of “outside broadcast of baseball” as shown in FIG. 3 and it is inputted to set up for selecting the Enter button 431. The recording and reproducing device 200 recognizes the program, which is selected by the user by the reserved screen display control means 253A of the record reservation setting means 253 in Step S112, and it is judged whether or not the selected program is the schedule change program in Step S113. When it is judged that the selected program is not the schedule change program in Step SI 13, the set-up cursor 550 is positioned at the confirm button 531 and the timer program set screen 500 having the extension time portion 524A on which “0 minute” is displayed is displayed in Step S114. Furthermore, when the record reservation setting means 253 recognizes an input of selecting the confirm button 531 in the record reservation information generating means 253B, it recognizes the time on the provisional record end time portions 513A as the end time of the recording in Step S115 and generates the record reserving information piece in which the end time of the recording or the like is assembled. Thereafter, the record reservation is set up by making the memory 240 memorize the record reserving information piece in Step S116, whereby the record reservation setting process using the EPG data is completed.

On the other hand, when it is judged that the selected program is the schedule change program in Step S113, the set-up cursor 550 is positioned at the extension time portion 524A and the timer program set screen 500 on which “30 minutes” is displayed is displayed in Step S117. When the record reservation information generating means 253B recognizes an input of setting up to select the confirm button 531, it further recognizes that a time after a lapse of the time on the extension time portion 524A from the time on the provisional record end time portions 513A in Step S118. Then the process of Step S116 is conducted. In this, 9:24 PM after 30 minutes of the extension time portion 524A from 8:54 PM of the provisional record end time portions 513A is recognized as the end time of the recording, and the process of Step S116 is conducted.

Function and Effect of Recording and Reproducing System

As described above, in the above embodiment, the processing unit 250 acquires the EPG data from the tuner 210 and makes these memorize in the memory 240. Thereafter, when the process unit 250 recognizes the input of setting up that the bill of fare screen 400 is displayed on the schedule-changed program identification means 252A of the bill-of-fare screen display control means 250, the process unit 250 acquires the EPG data from the memory 240. Then, the schedule-changed program identification means 252A respectively identifies the program of which broadcast time is possibly extended as the extension program and the program of which broadcast start time DOT is delayed in compliance with the event that the broadcast time of the extension program is extended as the delay program on the basis of the EPG data. Thereafter, the process unit 250 controls to display the schedule changing icon 417 in a shape of baseball cantaloup on the left side of the basic information piece 412 of the schedule change program by the bill-of-fare screen setting means 252B of the bill-of-fare screen display control means 252. Therefore, the user can judge whether or not there is an occasion where the broadcast DOT of the predetermined program is changed in view of the schedule changing icon 417 which is displayed along with the basic information piece 412 related to each of the programs of the bill of fare screen 400. Furthermore, the user can recognize not only the extension program of which broadcast time may be extended but also the delay program of which broadcast start TOD is delayed in conformity with the extension of the extension program as a program of which broadcast TOD is possibly extended. Furthermore, the user can judge whether or not the broadcast TOD is changed by a simple method of recognizing whether or not there is an occasion where the broadcast TOD is changed by means of a simple method of recognizing whether or not the display of the schedule changing icon 417 exists. Accordingly, the recording and reproducing device 200 can properly display the state of distributing the program data.

Furthermore, when the process unit 250 recognizes an issue that the schedule change program is selected as the program to be reserved for recording in the reserved screen display control means 253A, the set-up cursor is first displayed on the extension time area 524. Meanwhile, when it is recognized that the program other than the schedule change program is selected as a program to be reserved for recording, the set-up cursor 550 is displayed on the confirm button 531. Therefore, the recording and reproducing device can properly display the state of distributing the program data at the time of displaying the timer program set screen 500.

The reserved screen display control means 253A prompts the user to set up the extension time portion 524A so as to change the time of ending the record by displaying the set-up cursor 550 on the extension time area 524. Therefore, the user can change the time of ending the record without conducting the input of setting up to move the set-up cursor 550. Accordingly, it is possible to improve convenience of the recording and reproducing device in using the same.

Furthermore, the reserved screen display control means 253A displays “30 minutes”, “60 minutes”, “90 minutes”, “120 minutes” or the like for showing the record time to be extended on the extension time portion 524A. Therefore, it is sufficient for the user to input to set any one of the above described option times which are displayed on the extension time portion 524A. For example, it is much easier for a user to select according to the above structure than a structure that a user directly inputs to set a character string of, for example, “30 minutes”. Accordingly, the convenience of the recording and reproducing device 200 is further improved.

Furthermore, the schedule-changed program identification means 252A searches the individual program information piece having the character string of “extend” showing that an occasion where the broadcast time is possibly extended out of the ECG data, and identifies the program corresponding to the individual program information piece as the extension program. Therefore, the schedule-changed program identification means 252A can identify the extension program in use of a simple method of searching the character string for showing that there is an occasion where the broadcast time may be extended. Accordingly, it is possible to minimally suppress the load of the schedule-changed program identification means in processing the same to thereby easily demonstrate a high speed processing of identifying the extension program.

Furthermore, the schedule-changed program identification means 252A searches an individual program information piece which belongs to a large genre showing “sport” out of the EPG data, and the program corresponding to the searched individual program information piece is identified as the extension program. Therefore, for example, a drama which includes the character string “extend” in the content of the program shown in its detailed program information piece and of which broadcast time is not actually extended is not erroneously identified as the extension program by the schedule-changed program identification means 252A. Accordingly, the recording and reproducing device 200 displays a state of distributing program data more properly.

The schedule-changed program identification means 252A recognizes the broadcast end time of the extension program within any of the morning time zone, the afternoon time zone and the night time zone, and identifies a program which is started to be broadcasted in the time zone thus recognized as the delay program. Therefore, a program of which broadcast start time scarcely delays in compliance with the extension of the extension program in a statistic point of view such as a program that starts after a lapse of, for example, 10 hours is not identified. Accordingly, the recording and reproducing device 200 can further properly display the distribution state of the program data.

### Modification of the Embodiment

The present invention is not limited to the above embodiment and various modifications are possible as long as the purpose of the present invention can be achieved. In other words, although the structure that the display of the schedule changing icon 417 is set up on the basis of whether or not the program is the schedule change program, the invention is not limited thereto and, for example, a following structure can be adopted. In other words, it is possible to adopt a structure of displaying, for example, an issue of whether or not the schedule change program is in use of the character of the basic information piece 412 and/or a background display color. Furthermore, for example, it is possible to adopt a structure such that the characters of the basic information piece are displayed in a blinking state and characters of the basic information piece of a program other than the schedule change program are displayed in a continuously lighting state. According to such a structure, a user can recognize the schedule change program by observing, for example, the broadcast start time 414 and/or the program name 415, whereby it is unnecessary to move a line of vision to a position where a schedule changing icon 417 is displayed. Accordingly, the recording and reproducing device 200 can properly display the distribution state of the program data.

Furthermore, it is possible to adopt a structure of displaying whether or not it is the schedule change program in use of the size of the characters of the basic information piece 412. For example, the characters of the schedule change program of the basic information piece 412 may be made larger than those of the program other than the schedule change program. According to such a structure, a user can easily recognize an event that the program shown by the basic information piece 412 is the schedule change program 412. Accordingly, the recording and reproducing device 200 can further properly display the distribution state of the program data.

Furthermore, a structure of displaying the schedule changing icon 417, which corresponds to the genre of the extension program, may be adopted. For example, it is possible to adopt a structure such that the schedule changing icon 417 in the baseball cantaloup shape is displayed when the extension program is about baseball as described above, and a schedule changing icon 417 in a soccer ball shape is displayed when the extension program is about soccer. According to this structure, a user can recognize the genre of the extension program even when the basic information piece is not displayed on the basic information area 410. Therefore, the recording and reproducing device 200 can further properly display the distribution state of the program data.

Furthermore, it is possible to adopt a structure such that the time length of the extension time of the extension program is recognized and the basic information piece 412 and the schedule changing icon 417 are displayed in a display mode corresponding to the time length thus recognized. For example, it is possible to adopt a structure such that a display color of the background, the characters or the schedule changing icon 417 is set up to be red when the extension time is 30 minutes and blue when the extension time is an hour. According to such a structure, the user can recognize the broadcast start time of the delayed program when the extension program is extended in use of the display mode of the basic information piece 412 and/or the schedule changing icon 417 when, for example, the extension program is extended. Accordingly, the recording and reproducing device 200 can further properly display the distribution state of the program data.

Furthermore, it is possible to adopt a structure such that a basic information piece 412 and a schedule changing icon 417 respectively corresponding to the extension program are displayed in a mode different from those of a basic information piece 412 and a schedule changing icon 417 respectively corresponding to the delay program, the latter mode being different from in a display color and/or a display size. Furthermore, it is possible to display an extension program icon for showing the extension program and a delay program icon for showing the delay program, which have different display modes from each other without displaying the schedule changing icon 417. According to such a structure, a user can assuredly identify an event where the program of which broadcast time is to be changed is an extension program or a delay program in reference of the display modes of the basic information piece 412 and the schedule changing icon 417. Therefore, the recording and reproducing device 200 can further properly display the distribution state of the program data in comparison with the above embodiment of displaying the schedule changing icons 417 of the extension program and the delay program in the same display mode.

Although a structure of prompting the user a change of the time for ending the record by first displaying the set-up cursor on the extension time area 524 is exemplified, the invention is not limited thereto and, for example, the following structure or the like may be adopted. In other words, a structure such that the set-up cursor 550 is not displayed on the extension time area 524A and the display mode of the timer program set screen 500, for example a background and a display color of the characters, are set up on the basis of an issue of whether or not the program to be recorded is the schedule change program. According to such a structure, the user can recognize whether or not the program to be recorded is the schedule change program. Accordingly, the recording and reproducing device 200 can properly display the distribution state of the program data even in a time of displaying the timer program set screen 500.

Furthermore, although the structure that the extension of 30 minutes is displayed on the extension time portion 524A regardless of the extension time of the extension program has been exemplified, the invention is not limited thereto and, for example, the following structure may be adopted. Namely, an extendable time is calculated on the basis of the TOD shown by, for example, “to be extended until a maximum of 9:24 PM” of the detailed program information piece and the TOD of the broadcast end TOD of a broadcast TOD information piece, and the time thus calculated is displayed on the extension time portion 524A. According to such a structure, the recording and reproducing device 200 can display a time when to be first and actually extended on the extension time portion 524A. Accordingly, the recording and reproducing device 200 can further easily set up a record time to be extended in comparison with the above described various structures of the Embodiment.

Furthermore, although the structure that the extension program is identified by searching the individual program information piece having the large genre information piece of “sport” is exemplified, the invention is not limited thereto and a structure of identifying all of the individual program information pieces having the character string “extension” as the extension program may be adopted. According to such a structure, it is unnecessary to provide a function of searching the large genre in the schedule-changed program identification means 252A, and the structure of the schedule-changed program identification means 252A can be simplified. Accordingly, the cost of the recording and reproducing device 200 can be reduced.

Although the structure of identifying the program, which is started at the time zone of the broadcast end time, is exemplified above, the invention is not limited thereto and the structure such as follows may be adopted. Namely, it is possible to adopt a structure that all programs which are to be broadcasted after the broadcast end time of the extension program by 12 PM of the same date are identified as the delay program. According to the structure, the schedule-changed program identification means 252A can identify the delay program without processing to judge an issue that to which of the morning time zone, the afternoon time zone and the night time zone the broadcast end time of the extension program belongs. Accordingly, the load of processing the schedule-changed program identification means can be suppressed, and speeding-up of the process of identifying the delay program can be easily achieved.

Furthermore, it is possible to identify a predetermined number of programs to be broadcasted after the extension program, for example three programs, as the delay program. According to the structure, the schedule-changed program identification means 252A can identify the program which is to be broadcasted after the extension program and from 7:05 PM in the night time zone when, for example, the broadcast end time of the extension program is 6:57 PM in the afternoon time zone. Accordingly, the delay program can be identified irrespective of the time zone of the broadcast end time of the extension program, and the distribution state of the program data can be more properly identified in comparison with the structure of the above embodiment.

Furthermore, it is possible to adopt a structure that a program broadcasted within, for example, 3 hours is identified as the delay program. According to the structure, for example, in a case where the broadcast end time of the extension program is 5:54 AM in the morning time zone, the schedule-changed program identification means 252A does not identify the program broadcasted from, for example, 11 AM in the morning time zone which is hardly susceptible to an influence of the extension of the extension program. Accordingly, the delay program can be identified on the basis of an elapsed time from the broadcast end time corresponding to the susceptibility of the influence by the extension of the extension program, the distribution time is more properly identified in comparison with the structure of the above embodiment.

For example, it is possible to adopt a structure such that when it is recognized that a record reservation is set up for the schedule change program which is identified by the schedule-changed program identification means 252A, the TOD of the record reservation is changed to a TOD corresponding to the delay or the extension of the schedule change program. According to such a structure, it is possible to properly conduct a record process of the schedule change program without conducting a manipulation of changing the record reservation TOD. Accordingly, the convenience of the recording and reproducing device 200 in using this is further improved.

Furthermore, although the structure that the display control device according to the present invention is applied to the recording and reproducing device 200 which records program data for an analog broadcasting is exemplified, the invention is not limited thereto. For example, it is possible to use a TV broadcast program, a radio broadcast program, a satellite broadcast program, and music data, image data, an application software, a game software and various control programs which are distributed through a network as the program data. Furthermore, the structure is not limited to that applied to the recording and reproducing device 200, it is possible to apply to, for example, a display control device in which the EPG acquisition control means 251, the schedule-changed program identification means 252A, the bill-of-fare screen setting means 252B and the reserved screen display control means 253A are independently provided. Furthermore, it is possible to apply to a schedule-changed program display control device in which the EPG acquisition control means 251, the schedule-changed program identification means 252A and the bill-of-fare screen setting means 252B are independently provided.

Although the above-mentioned functions are constructed as a program, it is possible to construct by, for example, hardware such as a circuit board or an element such as a single integrated circuit (IC), wherein such a structure is applicable to any mode. Furthermore, when a structure of reading out of a program or a recording medium is adopted, handling becomes easy and use is easily expanded.

Other than that, the specific structure and procedure in practicing the present invention is properly changed to other structures or the like within a range where the purpose of the present invention is achieved.

As described, according to the above embodiment, the processing unit 250 of the recording and reproducing device 200 acquires the EPG data and makes the memory 240 memorize the EPG data. Furthermore, on the basis of the EPG data memorized in the memory 240, the processing unit 250 respectively identifies a program of which broadcast time is possibly extended as the extension program and a program of which broadcast start time delays in conformity with the occasion of the extension of the broadcast time of the extension program as the delay program. Therefore, a user can judge whether there is a case where the broadcast TOD of the predetermined program is changed or not in reference of the schedule changing icon 417, which is displayed along with the basic information pieces 412 related to each of the programs of the bill of fare screen 400. Furthermore, a user can recognize a delay program of which broadcast start TOD may delay in conformity with the extension of the extension program in addition to the extension program of which broadcast time may be extended as the program of which broadcast TOD may be changed. Accordingly, the recording and reproducing device 200 can properly display the distribution state of the program data.

The present invention is not confined to the configurations listed in the foregoing embodiments, but it is easily understood that the person skilled in the art can modify such configurations into various other modes, within the scope of the present invention described in the claims.

What is claimed is:

1. A display controlling apparatus comprising:
a data-related information acquiring device for acquiring a data related information having distribution information related to distribution of data;
a data identification device for identifying first data of having first distribution time, the first distribution time being extended or contracted and second data having second distribution time, the second distribution time being changed by the extension or contraction of the first distribution time of the first data; and
a distribution-state display controlling device for controlling to display information which suggests a possibility of changing each of the distribution times in addition to the distribution information of the first data and the second data.

2. The display controlling apparatus according to claim 1, wherein the data-related information has content character information showing the content of the data, and the distribution-state display controlling device controls to display at least one of the first and second distribution information and information which suggests a change in one of the first and second data in a display mode corresponding to a content of the content character information pieces.

3. The display controlling apparatus according to claim 1, wherein the distribution-state display controlling device controls to display at least one of the first and second distribution information and first and second information which suggest a change of each of the first and second data in a display mode corresponding to the first distribution time, the distribution time being extended or contracted.

4. The display controlling apparatus according to claim 1, wherein the distribution-state display controlling device controls to display at least one of the first distribution information and the first information which suggests a change in a display mode different from at least one of the second distribution information and the second information which suggests the change.

5. The display controlling apparatus according to claim 2, wherein the difference of display mode is caused by any one of the size, brightness, hue or color saturation of the display.

6. The display controlling apparatus according to claims 1, further comprising:
a requested information acquiring device for acquiring a requested information which result in making the data acquisition device to acquire the data; and
an acquisition-condition display controlling device for controlling to display acquisition conditions of the first and second data to be displayed on the display device by means of a display mode different from display modes of the data different from the first and second data when it is recognized that the data of which acquisition condition is requested are the first or second data.

7. The display controlling apparatus according to claim 6, wherein the acquisition-condition display controlling device controls to display acquisition-TOD-change prompting information piece, which prompts a change of TOD as the acquisition condition of the first or second data.

8. The display controlling apparatus according to claim 7, wherein the acquisition-condition display controlling means controls to display a predetermined time information piece for showing a predetermined time, which is obtained by adding to or subtracting from a TOD of the distribution time presuming that there is neither extension nor contraction at the time of changing the TOD of the acquisition time.

9. The display controlling apparatus according to claim 8, wherein the acquisition-condition display controlling device controls to display an extension or contraction time information for showing the extended or contracted time as the predetermined time information.

10. The display controlling apparatus according to claim 1, wherein the data-related information has a content character information showing the content of the data, and the data identification device identifies data corresponding to the content character information as the first data when it is recognized that an extension or contraction character information where the content character information is extended or contracted.

11. The display controlling apparatus according to claim 1, wherein the data identification device recognizes an end TOD of the first distribution time of the first data, and identifies the data distributed within the predetermined time from the end TOD as the second data.

12. A display controlling method for controlling to display a distribution condition of data comprising:
acquiring data related information having distribution information, which relates to distribution of the data;
identifying first data of which first distribution time is extended or contracted and second data of which second distribution time is changed by the extension or contraction of the first distribution time of the first data; and
controlling to display information, which suggests a change in one of the distribution times in addition to the distribution information of the first data and the second data.

13. The display controlling method according to claim 12, wherein the data-related information has content character information showing the content of the data.

14. The display controlling method according to claim 12 further comprising controlling to display at least one of the first and second distribution information and first and second information which suggest a change of each of the first and second data in a display mode corresponding to the first distribution time, the distribution time being extended or contracted.

15. The display controlling method according to claim 12 further comprising controlling to display at least one of the first distribution information and the first information which suggests a change in a display mode different from at least one of the second distribution information and the second information which suggests the change.

16. The display controlling apparatus according to claim 15, wherein the difference of display mode is caused by any one of the size, brightness, hue or color saturation of the display.

17. A computer product having a program tangibly demonstrating function of controlling to display a distribution condition of data comprising:
acquiring data related information having distribution information, which relates to distribution of the data;
identifying first data of which first distribution time is extended or contracted and second data of which second distribution time is changed by the extension or contraction of the first distribution time of the first data; and
controlling to display information, which suggests a change of each of the distribution times in addition to the distribution information of the first data and the second data.

18. The computer product according to claim 17 further comprising controlling to display at least one of the first and second distribution information and first and second information which suggest a change of each of the first and second data in a display mode corresponding to the first distribution time, the distribution time being extended or contracted.

19. The computer product according to claim 17 further comprising controlling to display at least one of the first distribution information and the first information which suggests a change in a display mode different from at least one of the second distribution information and the second information which suggests the change.

20. The computer product according to claim 19 wherein the difference of display mode is caused by any one of the size, brightness, hue or color saturation of the display.
